(19) United States
(12) Patent Application Publication
(10) Pub. No.: US 2009/0076986 A1
(43) Pub. Date: Mar. 19, 2009

(54) Advertising System

(76) Inventors: Kevin Cronin, Dublin (IE); Patrick Durkan, Dublin (IE); Barry Durkan, County Wicklow (IE)

Correspondence Address: JACOBSON HOLMAN PLLC, 400 SEVENTH STREET N.W., SUITE 600, WASHINGTON, DC, 20004, US

(21) Appl. No.: 12/223,709

(22) PCT Filed: Feb. 12, 2007
(86) PCT No.: PCT/IE2007/000017

§ 371 Date: Nov. 4, 2008

(30) Foreign Application Priority Data
Feb. 10, 2006 (IE) 2006/0094
Jan. 2, 2007 (IE) 2007/0001

(51) Int. Cl. G09F 15/00

(52) U.S. Cl. 705/500

(57) ABSTRACT

An advertising system comprises an advertisement (1, 25) and suspending means such as chains (2) for suspending the advertisement (1, 25) from the jib (4) of a tower crane (3). Preferably, the advertisement (1, 25) is suspended from a crane hook (6) and the advertisement system is attached to the jib (4) of the tower crane (3) only when the crane is not in normal use.

The invention relates to an advertising system for use with tower cranes.

Various systems have been proposed for using tower cranes to present advertising. Generally such known systems involve at least partially covering the mast of the tower crane with an advertising display. Such systems are generally complex and inconvenient to use and do not have a high advertising impact.

This invention is directed to providing an improved tower crane advertising system which will address the problems.

### STATEMENTS OF INVENTION

According to the invention there is provided a crane advertising system comprising an advertisement and/or an advertisement support and suspending means for suspending the advertisement support from a crane element carried by the jib or counter-jib of a tower crane.

In one embodiment of the invention the suspending means is for suspending the advertisement from the jib of a tower crane.

Preferably, the suspending means is for suspending the advertisement from a crane hook carried by the jib of a tower crane. In one embodiment the suspending means comprises a crane attachment for attaching to a crane hook.

The suspending means may be for releasable attachment to a crane hook.

In one case the crane attachment means comprises an attachment ring for attachment to a crane hook.

In one embodiment the suspending means comprises an at least partially non-rigid suspending means.

The suspending means may comprise at least one chain.

In one embodiment the suspending means is attached to the advertisement or advertisement support.

In one embodiment the advertisement support is of prefabricated construction.

An advertisement may be attached to the advertisement support.

In one case the advertisement is fixedly attached to the advertisement support.

In another case the advertisement is releasably attached to the advertisement support.

In one embodiment the advertisement and the advertisement support are integral.

The advertisement/advertisement support may comprises a representation of a branded product or service.

In one embodiment the advertisement support and/or advertisement presents at least one advertising space.

The advertising space may be of curvilinear form.

The advertising space may be of generally cylindrical form.

The advertising space may have more than one face.

At least one of the faces may be a substantially flat face.

In one embodiment the system comprises illumination means. The illumination means may be integral with or separate from the advertisement.

In one embodiment the advertisement and/or support have means for reducing effects due to wind.

The advertisement and/or support may be shaped to minimise effects due to wind.

The advertisement and/or support may have openings to reduce the effective wind load area.

In one embodiment the system comprises control means to limit the movement of the advertisement support or advertisement relative to the crane.

The control means may comprises a weight. The weight may be carried by the advertisement or advertisement support.

The control means may comprise means for raising and/or lowering the advertisement support or advertisement.

The raising and/or lowering means may comprise a pulley system. The pulley system comprises a cable and a motor for moving the cable to raise and/or lower the advertisement.

The invention also provides a tower crane comprising an advertisement system as of the invention suspended from the jib or counter-jib of the tower crane.

The invention further provides a tower crane comprising an advertisement system of the invention suspended from the jib of the tower crane.

In one embodiment the crane comprises a crane hook and the advertisement system is suspended from the crane hook.

The invention also provides a method of operating a tower crane comprising the step of suspending an advertisement system of the invention from a jib or counter-jib of a tower crane.

The invention further provides a method of operating a tower crane comprising the step of suspending an advertisement system of the invention from a jib of a tower crane.

In one particularly preferred aspect a method of operating a tower crane comprises the step of suspending an advertisement system of the invention from a crane hook of a tower crane.

The advertising system is preferably only mounted to the crane when the crane is idle.

The invention relates to hanging from construction tower cranes assemblies/systems with geometric shapes suitable for advertisement purposes.

The systems may have supporting structures covered by external faces. The advertisement can be attached to the external face, or be the external face itself. Lights can be used to show the advertisements, or the external face can be a light screen itself.

The system can be hung from the jib of a tower crane, especially the crane hook. The assembly can be moved by a system of cables, pulleys, and motors which is preferably the normal operating system of the crane.

The advertisement can be lighted at night by internal or external lights, or the face can be the light screen itself.

Construction tower cranes are high machines that can be seen from great distances. The invention provides a means to use them efficiently to show advertisements without interfering with the normal operation of the crane.

Preferably, the advertisement system is hung/suspended from the crane hook of the tower crane when the crane is idle. The crane is operated normally without the advertisement system attached and when the work of the crane is finished the advertisement system is readily attached to the crane hook.

The main source of loading is the wind load. To reduce wind effects on the advertisement, its supporting assembly, and the crane, one or both of the following measures can be used:
Shaping the assembly in such a way as to make it more aerodynamic with reduced wind load.
Providing openings in the advertisement and its supporting assembly to reduce the effective wind load area.

The “assembly” refers to the collection of components making the item hung from the tower crane. That includes the internal supporting structure, and the external faces.

For ease of transportation, the assembly can be made from small pieces that can be easily connected together. These smaller components can be connected by cables, wires, pins, rods, bolts, clamps, or similar components to produce a lightweight and flexible assembly. However it generally preferred that the system is prefabricated so that minimum site work is required.

To make the advertisement more noticeable at night time, internal or external lights can be used. With the recent progress in large screen displays, it is possible to make the whole external face from such displays. In this case, there is no need to physically change the advertisement media, as this can be simply achieved by changing the advertisement picture data file in the electronic control system of the display.

The assembly consisting of the supporting structure and the external face can be hung from a tower crane. Hanging the assembly can be achieved by using cables connecting the assembly to the crane jib or the counter jib. The cables are attached to pulleys and shafts controlled by a motor(s) that can be remotely controlled.

The assembly may be made from lightweight materials, so that its weight has only minimal effect on the crane. The main load on the assembly is due to wind effects. To reduce wind effects, the shape of the assembly can be made to be more aerodynamic with reduced wind loads. Also, openings can be provided to reduce the effective wind loaded area. The effect of wind load on the assembly is to induce movement in the wind direction. To control and limit this movement, added weights at the bottom of the assembly can be provided. These weights can be part of the supporting structure, or the external face.

The materials used to manufacture the assembly should be lightweight, cheap, durable, and strong. Examples of possible materials are plastic, aluminium, timber, fibreglass, or similar composite materials.

The external face can be made from a transparent or an opaque material. The advertisement can be attached to the external face, or be the external face itself. It can be made from hard or flexible materials, with or without openings. The advertisement can be lighted at night by lights placed inside or outside the assembly, or the face can be light screen itself. The lights should be safe to use and durable. Any type of lights can be used; however, the preferred types are low voltage halogen, fluorescent or light emitting diodes. If the face is a light screen, then there is no need to use external lights. The light screen can be made from light emitting diodes, liquid crystal displays, or similar devices.

This invention relates to hanging from construction tower cranes certain assemblies with geometric shapes suitable for advertisement purposes. The assembly has a supporting structure covered by the external face. The external shape of the assembly can have flat or curved surfaces. The assembly has a cross section that reduces the wind effects and can be provided with openings to reduce the wind effects. The external faces of the assembly can also have openings to reduce the wind forces. The advertisement can be attached to the external face, or be the external face itself. It can be made from a transparent, or an opaque material. Lights can be used to show the advertisements at night. These lights can be internal inside the supporting structure, or can be external. The external face can be made from a light screen itself. The internal structure and the external face are made from lightweight materials that can be assembled easily. The whole assembly can be hanged from the tower crane jib or counter jib. These assemblies can be raised, lowered, or moved using a system of cables, pulleys, and motor(s), most preferably using the crane book moving system of the crane itself.

### BRIEF DESCRIPTION OF THE DRAWINGS

The invention will be more clearly understood from the following description thereof given by way of example only, in which:—

FIG. 1 is an elevational view of a tower crane with an advertising system of the invention attached at two different locations;

FIG. 2 is a perspective view of a tower crane with an advertisement system of the invention suspended therefrom;

FIG. 3 is a perspective view of a tower crane with another advertisement system of the invention suspended therefrom;

FIG. 4 is a perspective view of one advertisement system of the invention;

FIG. 4A is an elevational view of an advertisement support of the system of FIG. 4;

FIG. 4B is another elevational view of the advertisement support of the system of FIG. 4;

FIG. 5 is a perspective view of an advertisement support of the system of FIG. 4;

FIG. 6 is an elevational view of the support of FIG. 5;

FIG. 7 is a cross sectional view on the line VII-VII of FIG. 6;

FIG. 8 is a perspective front view of one advertisement of the system of FIG. 4;

FIG. 9 is a perspective view from the rear of the advertisement of FIG. 8;

FIGS. 10(a) to 10(f) are cross-sectional views of alternative advertisement/advertisement supports of the invention;

FIG. 11 is a perspective view of a cylindrical advertisement/advertisement support with an internal structure shown in dotted outline;

FIG. 12 is a cross-sectional view of the system of FIG. 11;

FIG. 13 is a perspective view of another cylindrical advertisement advertisement support with an internal structure shown in dotted outline;

FIG. 14 is a cross-sectional view of the advertisement system of FIG. 13;

FIG. 15 is a perspective view of a generally flat advertisement/advertisement support;

FIG. 16 is a rear view of the system of FIG. 15;

FIG. 17 is a perspective view of another advertisement system of the invention;

FIG. 18 is a cross-sectional view on the line B-B in FIG. 17;

FIG. 19 is a side view of another advertisement system of the invention;

FIG. 20 is a rear view of the system of FIG. 19; and

FIG. 21 is a cross-sectional view on the line A-A in FIG. 19.

### DETAILED DESCRIPTION

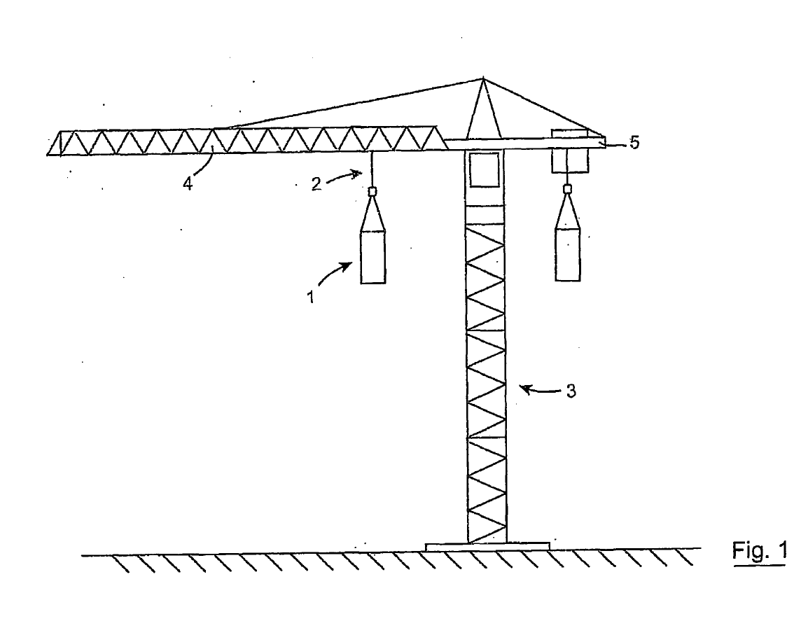

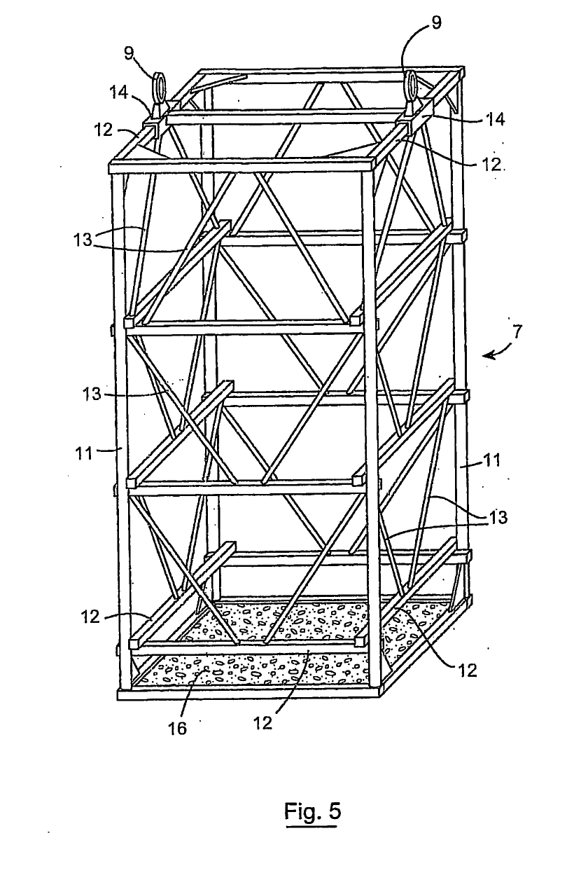

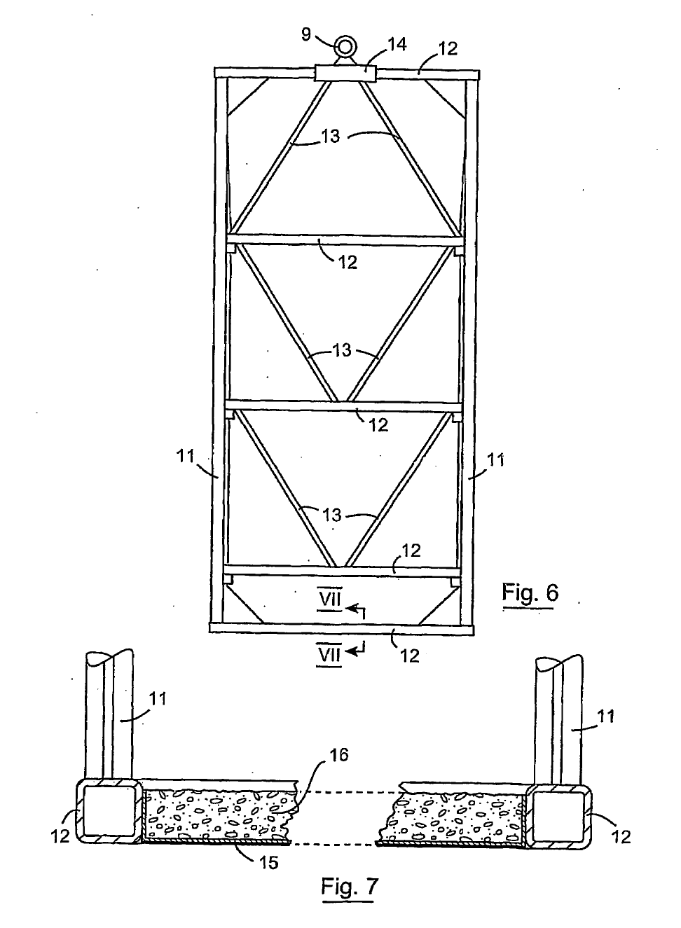

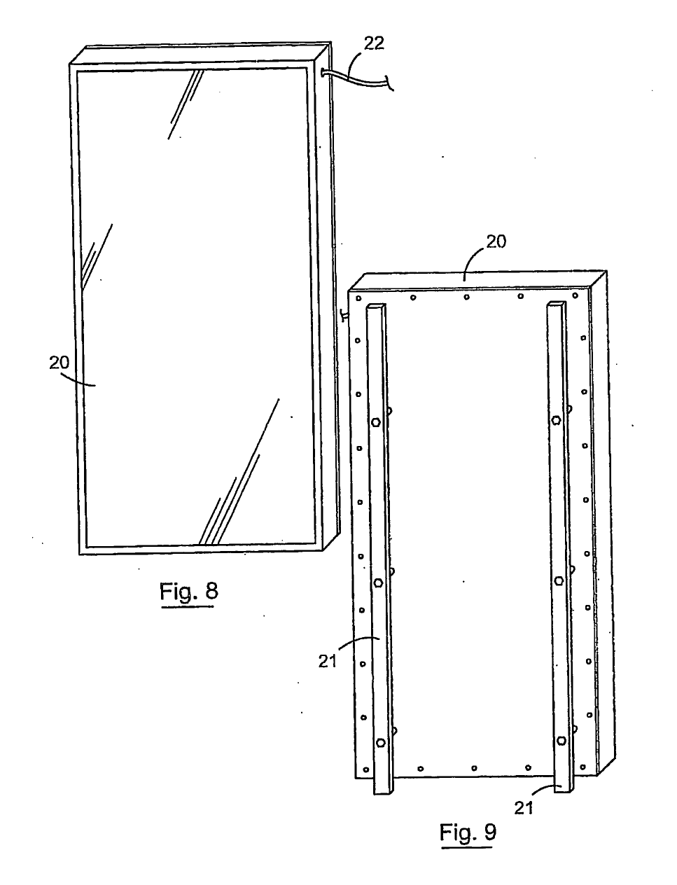

Referring to the drawings and initially to FIGS. 1 to 9 there is illustrated a crane advertisement system comprising an advertisement/advertisement support 1 and means, in this case cables or chains 2 for suspending the advertisement from a crane element carried by the jib 4 or a counter jib 5 of a tower crane 3. Preferably the advertisement/advertisement support 1 is suspended from the jib 4, especially from a crane element provided by a crane hook 6 carried by the jib 4 of the tower crane 3.

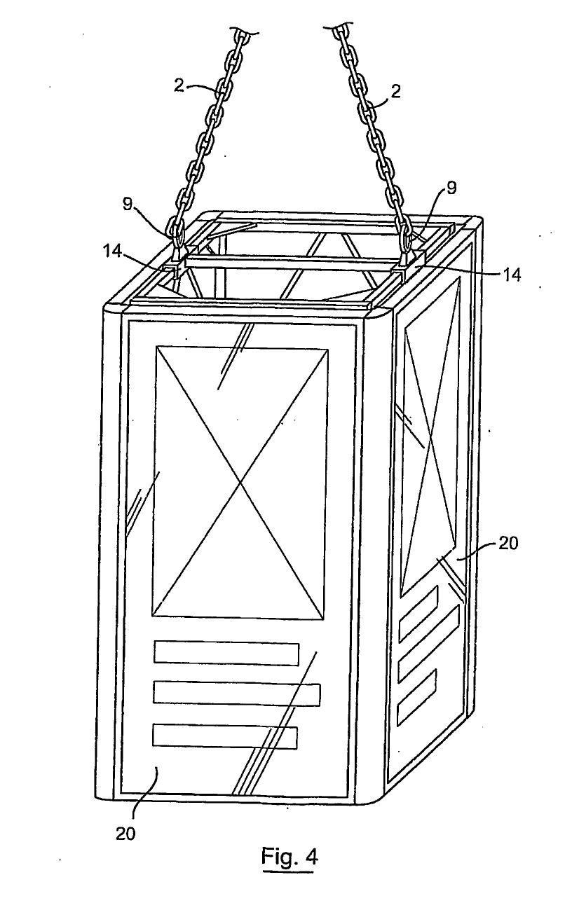

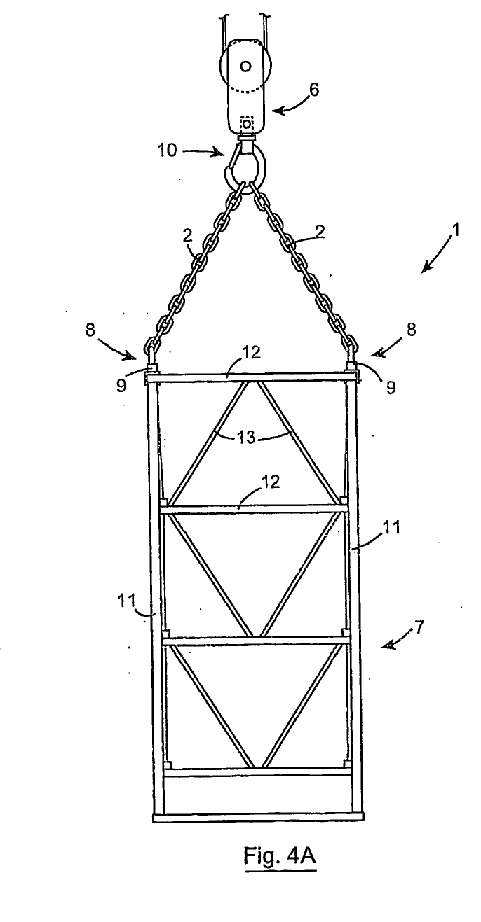

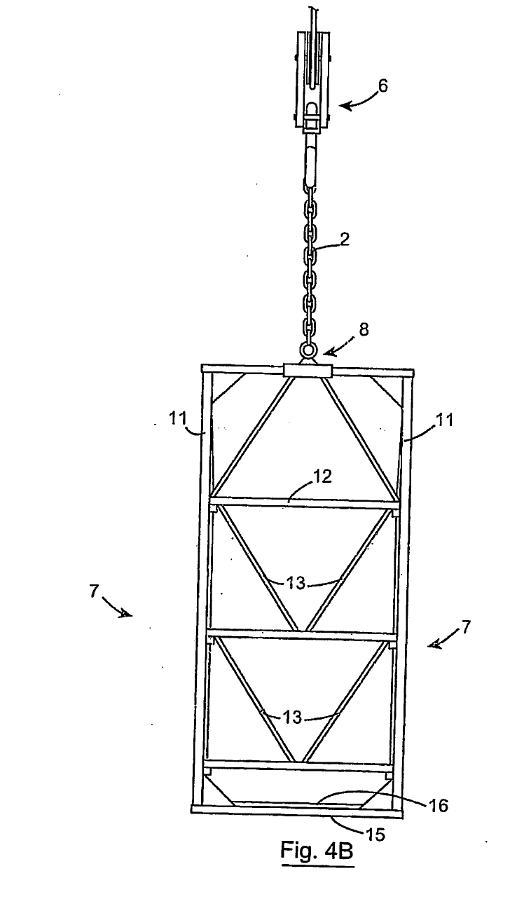

Referring in particular to FIGS. 4 to 9 an advertisement system 1 according to the invention which comprises an advertisement support 7 and suspension means, in this case chains 2 for suspending the support 7 from the crane hook 6. The chains 2 are connected to the support 7 by lock rings 8 at support points 9 at one end and are mounted to the crane hook 6 by way of a spring release clasp 10. The chains 2 are closed link chains with a typical safe working load of 5 ton.

The support is in this case of rectilinear shape and is prefabricated from uprights 11, cross members 12, and various stiffening ties 13. The support rings 9 are provided on sleeves 14 fixed to the upper cross members 12. The support 7 has a floor 15 which in this case is filled with a ballast weight 16, in this case of concrete or the like. The weight 16 assists in stabilising and controlling the advertisement system in use, for example against wind loads.

Advertisements in this case in the form of panels 20 are attached to the support 7, by any suitable attachment means such as bars 21 as illustrated particularly in FIG. 9. The panels may have a power supply connection 22 or an on-board power supply for lighting (such as backlighting). The panels 20 may have the advertisement integral therewith such as by being imprinted on a face thereof or an advertisement may be removably mounted in or to the panel 20.

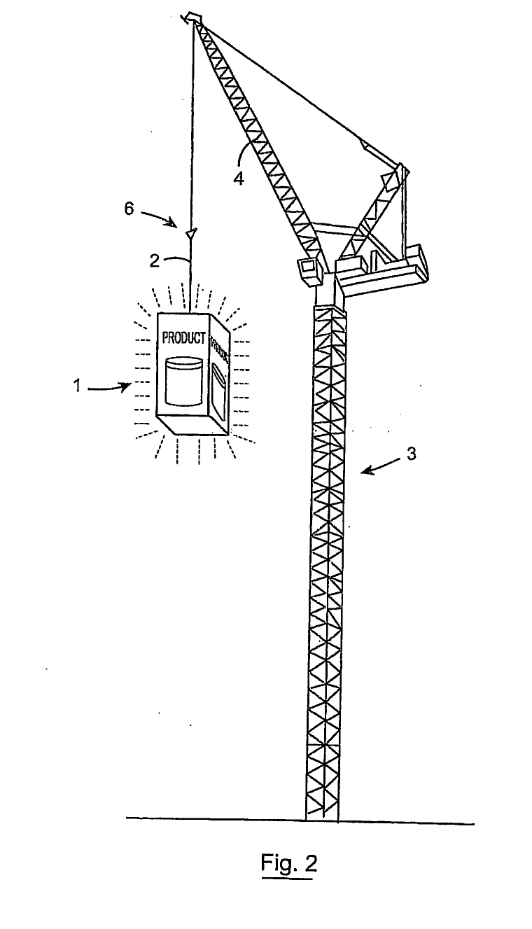

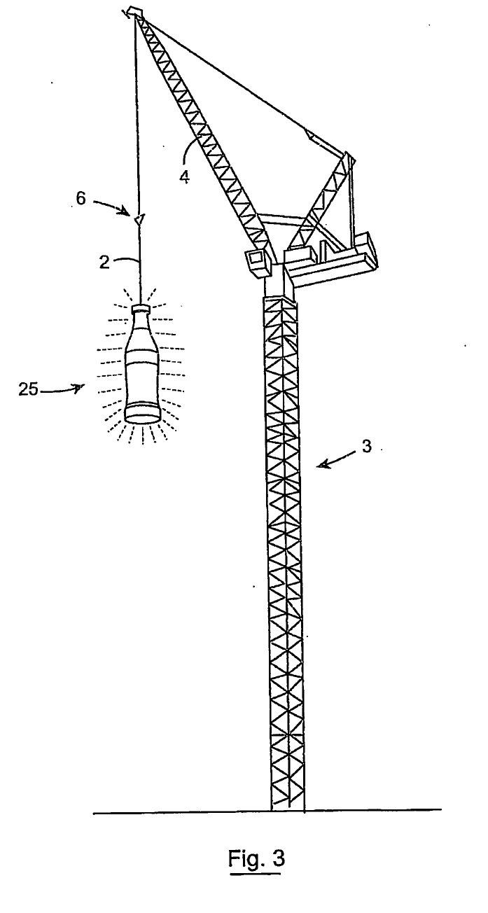

A typical advertisement system is illustrated in use in FIG. 2. Another system 25 is illustrated in FIG. 3 in which the advertisement and support are integral and may be in any suitable shape or form to present an image/brand of any product or service. The advertisement 25 may for example be in the shape of a bottle.

The advertisement system may be used when the tower crane is not in normal use. Thus, when a crane operator completes normal operation the advertisement system may be readily attached to the crane hook via a quick lock and release clasp. The advertising system is then lifted into position suspended by the crane and left in position. When the crane is to revert to normal operation, the advertisement system is simply lowered and disconnected from the crane hook. The crane is then used as normal. When crane operations are complete the cycle continues.

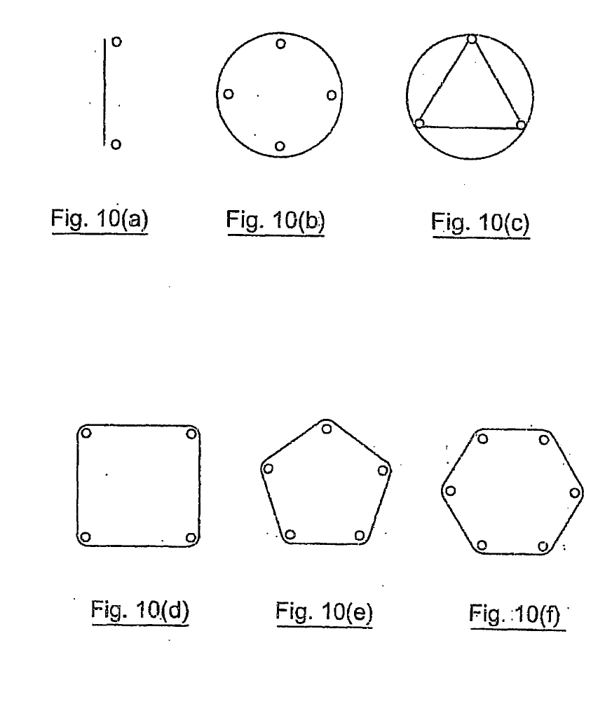

The advertising or support thereof can be of any desired shape such as those illustrated in FIGS. 10(a) to 10(f). Six possible shapes are shown. Other shapes, such as curved, elliptical, or multilateral are also possible. The shape can be prismatic having the same cross-section (a cylinder for example), or non-prismatic having variable cross-section (a cone for example).

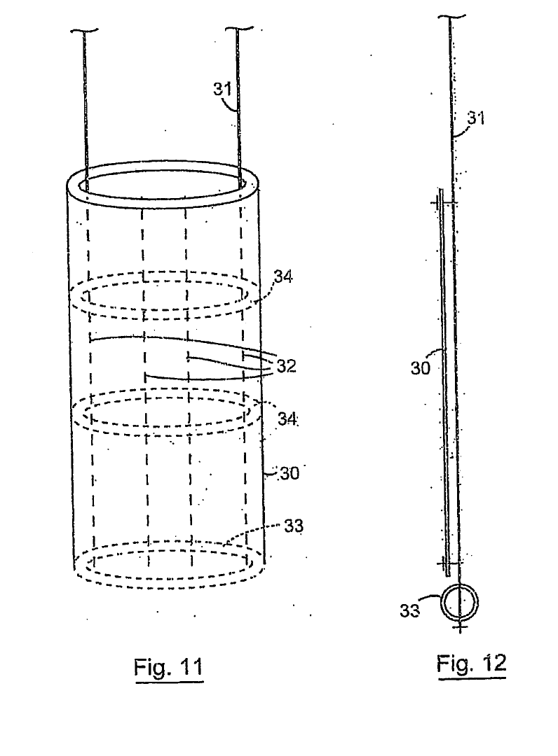

Referring to FIGS. 11 and 12, in this case an advertisement 30 is of generally cylindrical shape supported by hanging cables 31. There may also be internal supporting cables 32. The advertisement is weighted by a lower heavy ring 33 and there are a number of axially spaced-apart support rings 34.

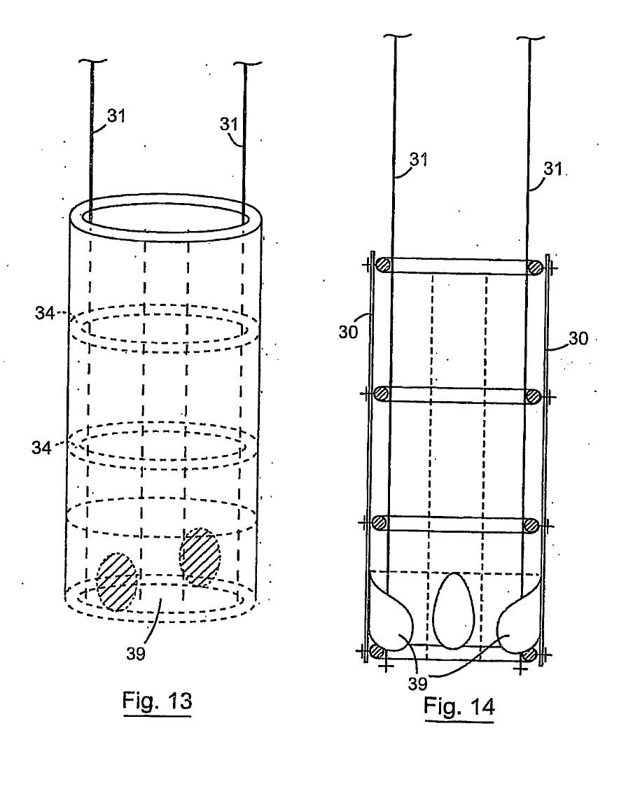

Referring to FIGS. 13 and 14 there is illustrated another system which is similar to that illustrated in FIGS. 11 and 12 and like parts are identified by the same reference numerals. In this case the advertisement is weighted by a bag 39 which may be filled with a material such as water.

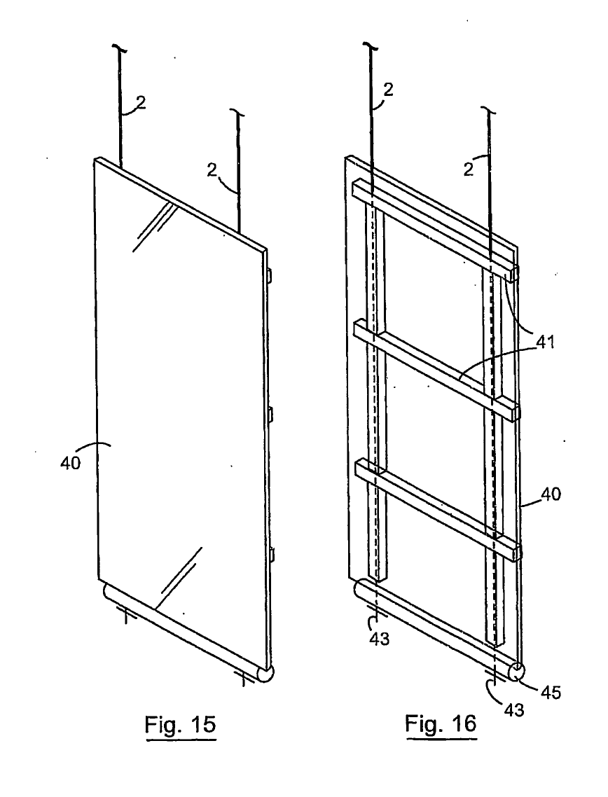

FIGS. 15 and 16 illustrate an alternative system using a flat advertisement 4D which may be releasably connected to horizontal bars 41 of a support system by any suitable releasable connectors. The lower end of the advertisement may be weighted by a steel bar 45 or the like, to which the cables 2 may be locked by cable locks 43.

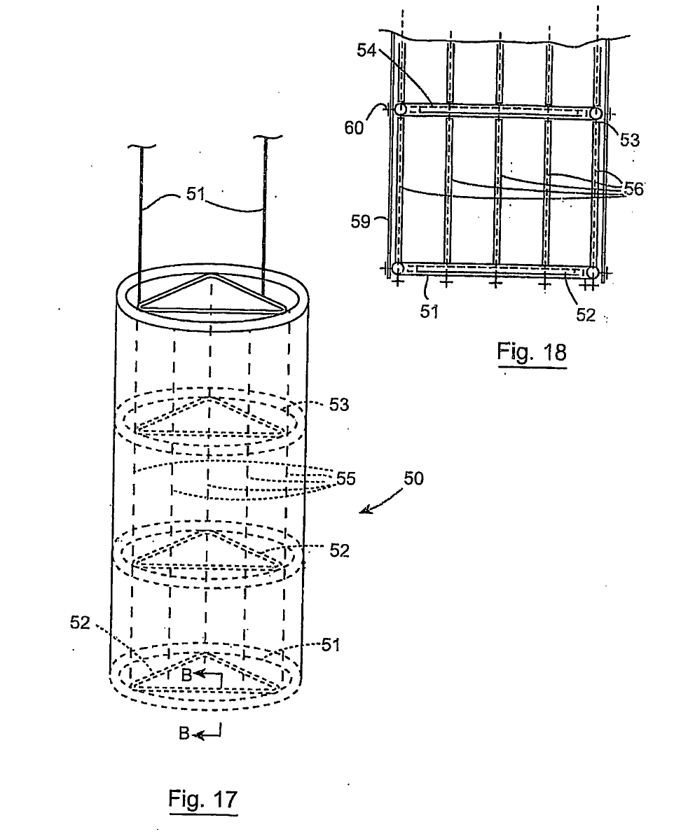

Referring to FIGS. 17 and 18 there is illustrated a curved triangular advertisement system 50. The system is similar to that described above and comprises an advertisement support structure which has a lower bar or pipe weight 51 which is reinforced by an internal triangle shaped support 52. There are a number of internal rings 53 which are also reinforced by triangular supports 54. Internal support cables 55 may be housed within plastic sleeves 56. An advertisement 59 may be releasably mounted to the support structure using connectors 60 as illustrated.

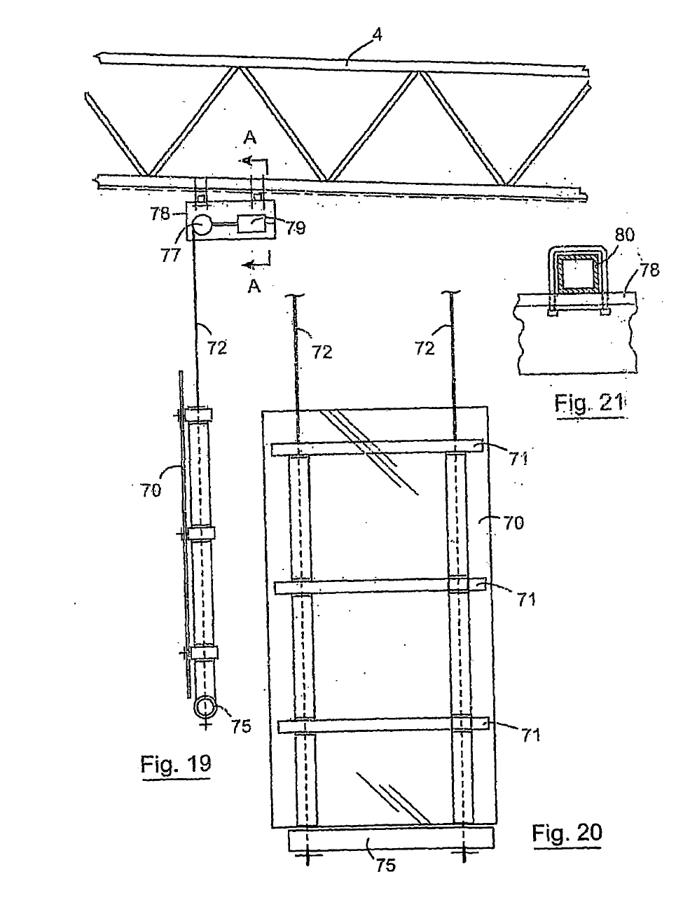

Referring to FIGS. 19 to 21, an advertisement 70 may be mounted to an advertising support which in this case comprises a number of horizontal bars 71 carried by a cable 72. Sleeves 73 interconnect the bars 71 and shield the cable. The lower end of the support is in this case weighted by a heavy bar 75 or pipe which may, for example, be of steel. Although it is preferred for ease of use as described that the advertisement is carried on a crane hook other arrangements are possible. For example, in this case at the upper end, the cable 72 is wound around a drum 77 in a lifting box 78. The drum 77 is drawn by a motor 79. The lifting box 78 may be mounted to a crane jib member 80 as illustrated in FIG. 23. The cables may be attached to the crane by pulleys, and shafts controlled by remotely controlled motor(s) to control the level of the assembly.

The main components and attachments can be described as follows:

Cables/Chains: These are used to suspend the advertisement/advertisement support on the jib of the tower crane.

Supporting Structure This is the inner support of the assembly that is forming the internal strong points to which the external face is attached. The structure is made from lightweight, cheap, durable, and strong material. Examples of possible materials are plastic, aluminium, timber, fibreglass, or similar composite materials. It can be made from smaller components that can be connected together for ease of transportation. The shape of the supporting frame can be varied according to the requirements. However, it needs to be streamlined to a more aerodynamic shape to produce less wind forces. Openings can be provided to reduce the effective wind loaded area.

External Face: This is the external faces of the assembly. It is supported on the supporting structure, or can be the supporting structure itself. It is the surface upon which the advertisement can be attached. It can be made from a transparent, or an opaque material. The external face is made from a lightweight, cheap, durable, and strong material. Examples of possible materials are plastic, aluminium, timber, fibreglass, or similar composite materials. It can be made from smaller components that can be connected together for ease of transportation. The shape of the external face should follow the shape of the supporting frame, and can be varied according to the requirements. However, it needs to be streamlined to a more aerodynamic shape to produce less wind forces. Openings can be provided to reduce the effective wind loaded area.

Weights: The effect of wind load on the assembly is to induce movement in the wind direction. To control and limit this movement, added weights at the bottom of the assembly can be provided. These added weights can be varied to result in a certain maximum movement in the wind direction due to a certain wind pressure on the assembly. These weights can be part of the Supporting Structure, or the External Face.

External Lights: Lights can be used to show the advertisements. These lights can be internal inside the supporting structure, or can be external. The external face can be made from a light screen itself. The lights should be safe to use and durable. Any type of lights can be used; however, the preferred types are low voltage halogen, fluorescent, or light emitting diodes. If the face is a light screen, then there is no need to use external lights. The light screen can be made from light emitting diodes, liquid crystal displays, or similar devices.

Advertisement: The advertisement can be attached to the external face, or be the external face itself. It can be made from hard or flexible materials, with or without openings. It can be part of the external face, and made from a light screen itself which can be made from light emitting diodes, liquid crystal displays, or similar devices.

Important features of the invention are:—

Advertisements are supported by the jibs or counter jibs of tower cranes. Advertisement assembly is supported by the jib or the counter jib, rather than the tower of the crane. This is a simpler and more flexible method of connection. This connection method allows the assembly to deflect in the wind direction in a controlled way. Control can be simply provided by a weight at the bottom part of the assembly.

Wind effects on the advertisement assembly can be reduced by having streamed line geometry. Openings can be provided to reduce the wind loaded area.

Movement due to wind load can be controlled by weights at the bottom of the assembly.

The advertisement assembly can be moved raised, lowered, or moved sideways using the cranes own operating system for the crane hook or alternative connection.

The assembly can be made from smaller components for ease of transportation.

The advertisement can be lighted at night by external or internal lights. The external face can also be made from a light screen.

The invention is not limited to the embodiments hereinbefore described which may be varied in detail.

1-39. (canceled)

40: A crane advertising system comprising an advertisement and/or an advertisement support and suspending means for suspending the advertisement support from a crane element carried by the jib or counter-jib of a tower crane.

41: The system as claimed in claim 40 wherein the suspending means is for suspending the advertisement from the jib of a tower crane.

42: The system as claimed in claim 41 wherein the suspending means is for suspending the advertisement from a crane hook carried by the jib of a tower crane.

43: The system as claimed in claim 40 wherein the suspending means comprises a crane attachment for attaching to a crane hook.

44: The system as claimed in claim 43 wherein the suspending means is for releasable attachment to a crane hook.

45: The system as claimed in claim 43 wherein the crane attachment means comprises an attachment ring for attachment to a crane hook.

46: The system as claimed in claim 40 wherein the suspending means comprises an at least partially non-rigid suspending means.

47: The system as claimed in claim 40 wherein the suspending means comprises at least one chain.

48: The system as claimed in claim 40 wherein the suspending means is attached to the advertisement or advertisement support.

49: The system as claimed in claim 40 wherein the advertisement support is of prefabricated construction.

50: The system as claimed in claim 40 wherein an advertisement is attached to the advertisement support.

51: The system as claimed in claim 49 wherein the advertisement is fixedly attached to the advertisement support.

52: The system as claimed in claim 49 wherein the advertisement is releasably attached to the advertisement support.

53: The system as claimed in claim 40 wherein the advertisement and the advertisement support are integral.

54: The system as claimed in claim 53 wherein the advertisement/advertisement support comprises a representation of a branded product or service.

55: The system as claimed in claim 40 wherein the advertisement support and/or advertisement presents at least one advertising space.

56: The system as claimed in claim 55 wherein the advertising space is of curvilinear form.

57: The system as claimed in claim 55 wherein the advertising space is of generally cylindrical form.

58: The system as claimed in claim 56 wherein the advertising space has more than one face.

59: The system as claimed in claim 58 wherein at least one of the faces is a substantially flat face.

60: The system as claimed in claim 40 comprising illumination means.

61: The system as claimed in claim 60 wherein the illumination means is integral with or separate from the advertisement.

62: The advertising system as claimed in claim 40 wherein the advertisement and/or support have means for reducing effects due to wind.

63: The advertising system as claimed in claim 62 wherein the advertisement and/or support are shaped to minimise effects due to wind.

64: The advertising system as claimed in claim 62 wherein the advertisement and/or support have openings to reduce the effective wind load area.

65: The system as claimed in claim 40 comprising control means to limit the movement of the advertisement support or advertisement relative to the crane.

66: The system as claimed in claim 65 wherein the control means comprises a weight.

67: The system as claimed in claim 66 wherein the weight is carried by the advertisement or advertisement support.

68: The system as claimed in claim 65 wherein the control means comprises means for raising and/or lowering the advertisement support or advertisement.

69: The system as claimed in claim 68 wherein the raising and/or lowering means comprises a pulley system.

70: The system as claimed in claim 69 wherein the pulley system comprises a cable and a motor for moving the cable to raise and/or lower the advertisement.

71: The tower crane comprising an advertisement system as claimed in claim 40 suspended from the jib or counter-jib of the tower crane.

72: The tower crane comprising an advertisement system as claimed in claim 40 suspended from the jib of the tower crane.

73: The tower crane as claimed in claim 72 wherein the crane comprises a crane hook and the advertisement system is suspended from the crane hook.

74: The method of operating a tower crane comprising the step of suspending an advertisement system as claimed in claim 40 from a jib or counter-jib of a tower crane.

75: The method of operating a tower crane comprising the step of suspending an advertisement system as claimed in claim 40 from a jib of a tower crane.

76: The method of operating a tower crane comprising the step of suspending an advertisement system as claimed in claim from a crane hook of a tower crane.

77: The method as claimed in claim 74 wherein the advertising system is mounted to the crane when the crane is idle.
